(19) United States
(12) Patent Application Publication
(10) Pub. No.: US 2002/0148706 A1
(43) Pub. Date: Oct. 17, 2002

(54) Continuous conveyor for conveying a material

(76) Inventors: Wolfram Baier, Ostfildern (DE); Guido Hettwer, Stuttgart (DE); Peter Rothfuss, Ditzingen (DE); Olaf Klemd, Markgroeningen (DE)

Correspondence Address: STRIKER, STRIKER & STENBY, 103 East Neck Road, Huntington, NY, 11743, US

(21) Appl. No.: 10/118,793

(22) Filed: Apr. 9, 2002

(30) Foreign Application Priority Data
Apr. 14, 2001 (DE) 101 18 564.2

(51) Int. Cl. B65G 23/14; B65G 15/60

(52) U.S. Cl. 198/833; 198/841

(57) ABSTRACT

A continuous conveyor for conveying material, has a supporting profile, a pulling element, a plate-shaped supporting element connected with the pulling element, at least one guiding rail for guiding the pulling element, the supporting profile being formed so that the pulling element extends in an inner region of the supporting profile, the guiding rail being arranged in the inner region of the supporting profile and guiding a lower region of the pulling element.

### BACKGROUND OF THE INVENTION

The present invention relates to a continuous conveyor for conveying a material to be conveyed. In particular it relates to a chain conveyor or a band conveyor.

Continuous conveyors are known in many modifications. Some of them are disclosed for example in the German patent documents DE 31 04 262 A1 and DE 32 13 986 C2 and formed as chain conveyors which have a conveyor chain mounted in a supporting profile. A plurality of conveying plates are arranged on the conveyor chain, and extend outside of the supporting profile. For minimizing a friction between the plates and the supporting profile a U-shaped sliding rail is provided in the upper region of the supporting profile. When the conveyor is used in dirty areas, such as for example in production regions, chips or dirt can reach the conveyor chain and the sliding regions or the regions between the conveyor and the supporting profile and can cause an increased friction or wear of the components and in the extreme situations can lead to blocking of the conveyor.

Also, in the known conveyors there are problems with curved conveyor paths, in which the conveyor chain is guided over curves.

### SUMMARY OF THE INVENTION

Accordingly, it is an object of the present invention to provide a continuous conveyor for conveying materials, which avoids the disadvantages of the prior art.

In keeping with these objects and with others which will become apparent hereinafter, one feature of the present invention a continuous conveyor for conveying materials which has a supporting profile; pulling means; a plate-shaped supporting element connected with the pulling means; at least one guiding rail for guiding said pulling means, said supporting profile being formed so that said pulling means extend in an inner region of said supporting profile, said guiding rail being arranged in said inner region of said supporting profile and guiding a lower region of said pulling means.

When the continuous conveyor is designed in accordance with the present invention, a guiding rail is arranged in the inner region of a supporting profile. Therefore the guiding rail guides a lower region of a pulling means. A protection from dirt and chips is provided, so that the chips can not reach an area between the pulling means and the guiding rail. As a result, the inventive continuous conveyor can be used in particular in dirty environment.

In accordance with a further feature of the present invention, the guiding rail has an L-shaped cross-section. This makes possible a lateral guidance of the pulling means for a conveyor which is guided over curves. Thereby the pulling means are laterally guided by the guiding rail.

In accordance with another feature of the present invention, two guiding rails are provided. This makes possible a guidance of the pulling means at both sides, and in particular a lateral guidance both over the left and right curves.

In accordance with a further preferable embodiment of the present invention, the guiding rail is arranged between webs, and the webs are formed on the supporting profile of the continuous conveyor. This provides a simple mounting of the guiding rails. It is particularly advantageous when between the webs and the guiding rails, a press fit is provided. Thereby simple mounting and dismounting processes can be realized, and the mounting time can be retained very short.

In the inventive continuous conveyor it is especially advantageous when the pulling means is formed as a chain. With this construction curved conveying paths with different radii can be realized.

In accordance with a preferable embodiment of the present invention, the pulling means is guided both in its lower region and its upper region. It is especially advantageous to form projections which are oriented horizontally at the upper region of the supporting profile, so that additional upper guiding rails can be mounted on them.

All guiding rails which are used in the continuous conveyor of the invention can be designed identical, to reduce the cost of production. In other words, all guiding rails of the continuous conveyor of the present invention have the same profile.

It is especially advantageous when the guiding rails are composed of synthetic plastic. The synthetic plastic must have a minimal friction coefficient, so that the friction between the guiding rails and the pulling means is minimized. The supporting profile is composed preferably of aluminum.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a section of a chain conveyor with a guiding rail in accordance with the present invention.

### DESCRIPTION OF THE PREFERRED EMBODIMENT

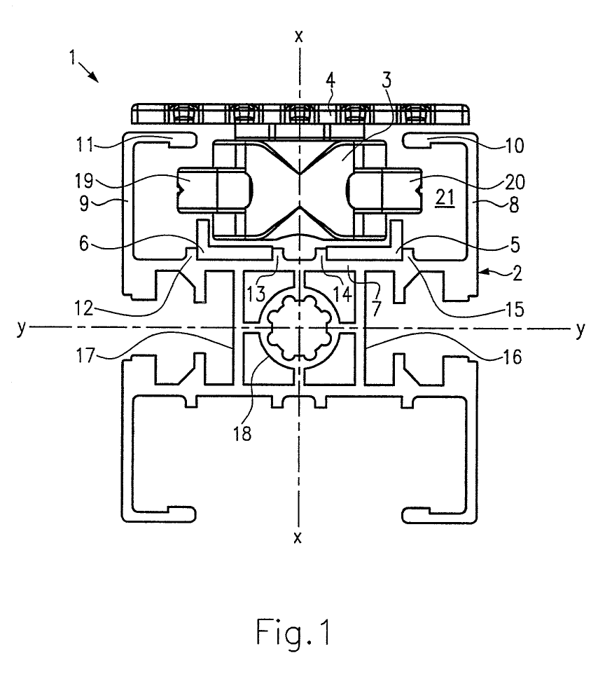

A continuous conveyor in accordance with the present invention with an inventive guiding device is illustrated as a chain conveyor which is identified with reference numeral 1 in FIG. 1.

As can be seen from the drawing, the chain conveyor 1 has a supporting profile 2 which is formed symmetrically to a central axis X-X. The supporting profile 2 has a core region 18. Bottom regions 7 are arranged on two opposite sides of the core region 18. Wall regions 8, 9 are provided perpendicular to the bottom region.

Projections 10 and 11 are formed on the wall regions 8, 9 perpendicularly to the same, as can be seen in FIG. 1. Thereby an inner region 21 is formed on the supporting profile 2. As shown in FIG. 1, the supporting profile is formed also symmetrically to an axis Y-Y. For better visibility, in FIG. 1 only one half of the supporting profile is shown and identified with corresponding reference numerals.

The chain conveyor further has a pulling means 3 formed as a chain. A plurality of plate-shaped transporting elements 4 are arranged on the pulling chain 3. They are used for positioning of the materials to be conveyed. Two guided rails 5 and 6 are arranged in the inner region 21 of the supporting profile 2.

The guiding rails 5 and 6 are substantially L-shaped and are mounted on the bottom region 7 of the supporting profile 2. Four webs 12, 13, 14, 15 are formed on the bottom region 7 for mounting of the guiding rails 5, 6. The guiding rails 5, 6 are mounted between two webs with a press fit.

As shown in FIG. 1, the guiding rails 5 and 6 are arranged in the mounted condition so that a region of the guiding rails projects vertical to the bottom region 7. The lower region of the chain 3 is thereby arranged between the both vertical regions of the guiding rails 5 and 6. Thereby the chain 3 is laterally guided in its lower region and can be placed on the guiding rails 5, 6. This provides for a very good curving of the inventive continuous conveyor.

Furthermore, the chain 3 slides on the other leg of the guiding rails 5 and 6. Moreover the leg of the guiding rails 5 and 6 which is arranged vertically to the lower bottom region 7 prevents penetration of dirt or chips between the guiding rails and the chain 3.

Regions 19 and 20 which project laterally on the chain 3 are further provided. Therefore chips which fall from above can not reach an area between the chain 3 and the guiding rails 5 and 6. As a result of these measures, the inventive continuous conveyor has a very high operational safety and can operate in contaminated regions, such as for example halls of manufacturing enterprises.

As shown in FIG. 1, furthermore two grooves 16 and 17 are provided on the supporting profile 2. They facilitate mounting of additional devices on the supporting profile 2 of the continuous conveyor 1. For example, a lateral guide can be mounted for the objects to be transported. Individual supporting profiles 2 can be connected under one another, for example on the core region 18. The supporting profile 2 is preferably composed of aluminum.

In accordance with the present invention the continuous conveyor 1 for conveying a materials to be conveyed includes the supporting profile 2, the pulling means 3, and the plate-shaped transporting element 4. The plate-shaped transporting element4 is connected with the pulling means 3. The pulling means extend in an inner region 21 of the supporting profile 2. Furthermore, the continuous conveyor 1 also includes the guiding rails 5 and 6 for guiding the pulling means. The guiding rail is arranged in the inner region of the supporting profile 2 and guides a lower region of the pulling means 3.

It will be understood that each of the elements described above, or two or more together, may also find a useful application in other types of constructions differing from the types described above.

While the invention has been illustrated and described as embodied in continuous conveyor for conveying a material, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A continuous conveyor for conveying materials, comprising a supporting profile; pulling means; a plate-shaped supporting element connected with the pulling means; at least one guiding rail for guiding said pulling means, said supporting profile being formed so that said pulling means extend in an inner region of said supporting profile, said guiding rail being arranged in said inner region of said supporting profile and guiding a lower region of said pulling means.

2. A continuous conveyor as defined in claim 1, wherein said at least one guiding rail is L-shaped for laterally guiding said pulling means.

3. A continuous conveyor as defined in claim 1; and further comprising a second such guiding rail, said both guiding rails being arranged in said inner region of said supporting profile.

4. A continuous conveyor as defined in claim 3, wherein said supporting profile is provided with webs, said guiding rails being arranged between said webs.

5. A continuous conveyor as defined in claim 4, wherein said webs and said guiding rails are arranged with a press fit.

6. A continuous conveyor as defined in claim 1, wherein said pulling means includes a chain.

7. A continuous conveyor as defined in claim 1, wherein said supporting profile has projections; and further comprising additional guiding rails arranged on said projections.

8. A continuous conveyor as defined in claim 1; and further comprising at least one further guiding rail, said guiding rails having an identical profile.

9. A continuous conveyor as defined in claim 1, wherein said at least one guiding rail is composed of synthetic plastic.

10. A continuous conveyor as defined in claim 1, wherein said supporting profile is composed of aluminum.
